(19) United States
(12) Patent Application Publication
(10) Pub. No.: US 2013/0133902 A1
(43) Pub. Date: May 30, 2013

(54) FIRE SPRINKLER HEAD MOUNTING ASSEMBLY

(71) Applicant: RAPIDROP GLOBAL LIMITED, Peterborough (GB)

(72) Inventors: Alan Stimpson, Gainsborough (GB); Daniel Gill, Rutland (GB); Stuart Carnegie, Peterborough (GB); Keith Plater, Ampthill (GB); Christopher Boon, Basingstoke (GB); Andrew Miller, Conwy (GB); Michal Multaniak, Rutland (GB)

(73) Assignee: RAPIDROP GLOBAL LIMITED, Peterborough (GB)

(21) Appl. No.: 13/653,693

(22) Filed: Oct. 17, 2012

Related U.S. Application Data
(60) Provisional application No. 61/564,362, filed on Nov. 29, 2011.

(51) Int. Cl. A62C 31/28

(52) U.S. Cl. 169/51

(57) ABSTRACT

A mounting assembly for mounting a fire sprinkler head in a suspended ceiling supported by a grid of suspended rails includes a tubular sprinkler reducer, a latitudinal supporting member, and a mounting bracket. The tubular sprinkler reducer includes an upper end connectable to a sprinkler supply pipe and a lower end connectable to a sprinkler head. The latitudinal supporting member includes a supporting bracket on each end for attachment to the suspended rails. The mounting bracket is located around an intermediate region of the sprinkler reducer and has first and second spaced-apart flanges extending to one side that define between them a horizontally-extending mounting channel into which the latitudinal supporting member can be inserted. The mounting bracket further includes at least one closure member for closing the mounting channel after the latitudinal supporting member is inserted therein.

### FIELD OF THE INVENTION

This invention relates to a fire sprinkler head mounting assembly for locating, supporting and securing a sprinkler head in a suspended ceiling.

### BACKGROUND TO THE INVENTION

Sprinkler systems are provided to spray water in the event of a fire. A sprinkler head is connected to a water supply and is activated when a seal retaining the water is released. It is usual for the seal to be released by the application of heat from a fire.

Sprinkler heads are usually installed into the ceiling of a building. In suspended ceilings, the pipework for the water supply is hidden above the ceiling panel with just the head of the sprinklers protruding through holes of pre-determined size in the ceiling. A typical suspended ceiling construction consists of a grid of suspended supporting rails, with ceiling panels carried between them.

The inlet bore of a sprinkler head is less than that of the water supply pipework. It is therefore necessary to provide a sprinkler reducer in order for the sprinkler head to be fitted to the pipework. A sprinkler reducer is typically of tubular construction having at one end an internal bore corresponding with a standard bore of system water supply pipes. The sprinkler reducer is usually screwed on to the system water supply pipe. The other end of the sprinkler reducer has an internal thread corresponding with the outer thread of the inlet on a sprinkler head. The portion of the sprinkler reducer in between the inlet and outlet sections will usually be of uniform cross section.

Traditionally, it was required for the system to be pressure tested twice during installation. The first test was carried out after installation of the main water supply. The outlets are plugged and the test is performed. The use of fixed water supply pipes extending from the outlets on the main water supply meant that a further pressure test was required upon installation of said pipes. The use of flexible pipes connected to the main water supply outlets can remove the need for a second pressure test. The flexible pipes used in sprinkler installations are corrugated metal tubes, typically of stainless steel, which can be bent by hand into the desired configuration.

Two alternative approaches to mounting the sprinkler head using flexible pipes are commonly used:
If the sprinkler head is mounted in the reducer at the first fix, thus avoiding the need for a further pressure test, the mounting bracket must first be attached to the reducer, which means that the latitudinal supporting member must be inserted into the mounting bracket and then mounted on the suspended supporting rails of the ceiling with the completed assembly in place. In a limited ceiling void, this can be difficult, and therefore time-consuming;
The mounting bracket is first attached to the latitudinal supporting member in such a position that the mounting slot for a sprinkler reducer lines up with a hole of pre-determined size and position in the ceiling panel. Once the bracket is in place, the sprinkler reducer has to be inserted into the mounting bracket. In this case, the sprinkler head has to be attached after the reducer has been secured in place, which means that a second pressure test will need to be carried out. In addition, the mounting can sometimes be difficult to achieve in the reduced space available above a suspended ceiling, and so the time required for installation is increased, thereby increasing installation costs.

U.S. Pat. No. 7,735,787 (Kafenshtok et al) discloses an assembly for locating and supporting a sprinkler reducer into a ceiling. A fixed bar and bracket assembly is provided, comprising a latitudinal supporting member having two opposing ends being received into respective longitudinal mounting brackets. The longitudinal mounting brackets engage with respective ceiling frame members to provide a stable mounting point for the sprinkler head assembly. A slidable mounting bracket is mounted on the latitudinal supporting member and is configured to receive the sprinkler reducer in a side opening, which is then closed by means of a swivel-mounted fastener. The fastener tends to urge the reducer into engagement with the latitudinal supporting member to hold the whole assembly in the desired position.

It is generally specified that the frame arm of a sprinkler head must be in line with each other or the ceiling structure. The sprinkler reducer mounting assembly of Kafenshtok et al requires that the mounting bracket is fitted to the latitudinal supporting member before the sprinkler reducer is received into the bracket. It is therefore difficult to ensure that the frame arms on the sprinkler heads are aligned with each other and with the ceiling structure.

### SUMMARY OF THE INVENTION

The fire sprinkler head mounting assembly of the present invention enables the installation of a sprinkler head to be achieved by the alternative desired means.

Accordingly, the invention provides a fire sprinkler head mounting assembly for mounting a sprinkler head in a suspended ceiling, the suspended ceiling comprising a grid of suspended rails supporting ceiling panel members between them, the assembly comprising:

a tubular sprinkler reducer having an upper open end provided with a connector for a flexible sprinkler supply pipe and a lower open end adapted to receive a sprinkler head;

a latitudinal supporting member having fixed adjacent to each opposed end thereof a respective supporting bracket which is in turn carried by and attached to a respective one of the suspended rails; and

a mounting bracket located around the sprinkler reducer at a position intermediate said upper and lower open ends, the bracket having first and second spaced-apart flanges extending to one side of the sprinkler reducer to define between them a horizontally-extending mounting channel into which the latitudinal supporting member can pass when the mounting bracket carrying the sprinkler reducer is located on to the latitudinal supporting member, the mounting bracket comprising at least one closure member for closing the mounting channel after the latitudinal supporting member is located therein.

The latitudinal supporting member is preferably of square, rectangular or channel cross section and is supported by two longitudinal supporting brackets, one at each end of the latitudinal supporting member. The longitudinal support brackets engage with the top portion of respective ceiling frame members to suspend the latitudinal supporting member above the elevation of the ceiling frame members.

The sprinkler reducer mounting bracket preferably has a pair of spaced-apart flanges extending to one side of the sprinkler reducer to define between them a horizontally-extending recess. Both flanges have corresponding apertures which receive a sprinkler reducer. Either the upper or lower flange has provided, opposite to a base wall, a locking unit which engages with the opposite flange to retain the sprinkler reducer.

A number of different locking unit designs are described in detail below. Preferably, the locking unit will comprise, at least two locking pins joined together by a locking plate. The locking pin and plate assembly locates through pre-determined holes in the top flange and when closed is pushed through corresponding holes in the bottom flange.

Preferably, a set screw is provided which threads through a threaded hole in the base wall. The set screw, when tightened, pushes against a retaining bracket which makes contact with a sprinkler reducer and pushes it hard against the latitudinal supporting member. The latitudinal supporting member, in turn, pushes the locking pins into the portion of a key-hole style slot having reduced diameter. This prevents the locking unit being raised until the bolt is released.

Provision of such a pre-assembly comprising a sprinkler reducer and mounting bracket has certain advantages. The mounting bracket is provided with a substantially square hole into which a cylindrical sprinkler reducer, having flat spots forming the edges of a square, locates. The engagement of the flat spots on the sprinkler reducer with the edges of the square aperture prevents the sprinkler reducer from being rotated once installed into the mounting bracket.

The prevention of rotation of the sprinkler reducer means that once the pre-assembly of a sprinkler reducer and sprinkler head is installed into the mounting bracket, the position of the frame arms on the sprinkler head is fixed. Such an assembly allows for the consistent alignment of frame arms with the ceiling structure.

The pre-assembly of the majority of components at ground level additionally reduces the time required to be spent working in a confined space above a suspended ceiling.

Further advantages have been found during dismounting of the sprinkler system. The embodiments as described below allow for a greater applied torque during dismounting than in prior art assemblies.

It will be appreciated that other locking unit designs, including but not limited to the embodiments described below, could be used. Other advantages and features of the invention are described in the following detailed description and claims.

### BRIEF DESCRIPTION OF THE DRAWINGS

In the drawings which illustrate exemplary embodiments of the invention:

FIG. 1 shows an isometric view (front, top, left) of a traditional prior art mounting assembly housing a flexible sprinkler assembly;

FIG. 2 shows an isometric view (front, top, left) of a first embodiment having a bracket with a swivel locking stop bolt mounted on a latitudinal supporting beam;

FIG. 3 shows an isometric view (front, top, left) of the bracket from FIG. 2, shown separate to the latitudinal supporting beam;

FIG. 4 shows an isometric view (front, top, left) of the bracket from FIG. 2, shown mounted in position on the latitudinal supporting beam;

FIG. 5 shows a side elevation of the bracket from FIG. 2;

FIG. 6 shows an isometric view (back, top, right) of the bracket from FIG. 2;

FIG. 7 shows an isometric view (front, top, left) of a second embodiment of bracket, shown separate to the latitudinal supporting beam;

FIG. 8 shows an isometric view (front, top, left) of the bracket from FIG. 7, shown mounted on the latitudinal supporting beam;

FIG. 9 shows a side elevation of the bracket from FIG. 7;

FIG. 10 shows an isometric view (back, top, right) of the bracket from FIG. 7, enlarged and showing the main body of the bracket, the locking pins and a set screw;

FIG. 11 shows an isometric view (front, top, left) of a third embodiment of bracket, shown separate to the latitudinal supporting beam;

FIG. 12 shows an isometric view (front, top, left) of the bracket from FIG. 11, shown mounted on the latitudinal supporting beam;

FIG. 13 shows a side elevation of the bracket from FIG. 11;

FIG. 14 shows an isometric view (back, top, right) of the bracket from FIG. 11, enlarged and showing the main body of the bracket, the locking pins and a winged screw;

FIG. 15 shows an isometric view (front, top, left) of a fourth embodiment of bracket, shown separate to the latitudinal supporting beam;

FIG. 16 shows an isometric view (front, top, left) of the bracket from FIG. 15, shown mounted on the latitudinal supporting beam;

FIG. 17 shows a side elevation of the bracket from FIG. 15;

FIG. 18 shows an isometric view (front, top, left) of the bracket from FIG. 15, enlarged and showing the main bracket body, the hinge wire and two set screws;

FIG. 19 shows an isometric view (front, top, left) of a fifth embodiment of bracket, shown separate to the latitudinal supporting beam;

FIG. 20 shows an isometric view (front, top, left) of the bracket from FIG. 19, shown mounted on the latitudinal supporting beam;

FIG. 21 shows a side elevation of the bracket from FIG. 19;

FIG. 22 shows an isometric view (front, top, left) of the bracket from FIG. 19, enlarged and showing the main bracket body and set screws;

FIG. 23 shows an isometric view (front, top, left) of a sixth embodiment of bracket, shown separate to the latitudinal supporting beam, in this embodiment, the latitudinal supporting beam is a channel section;

FIG. 24 shows an isometric view (front, top, left) of the bracket from FIG. 23, shown mounted on the latitudinal supporting beam;

FIG. 25 shows a side elevation of the bracket from FIG. 23;

FIG. 26 shows an isometric view (front, top, left) of the bracket from FIG. 23, enlarged and showing the main bracket body, retaining sleeve and set screws.

### DETAILED DESCRIPTION OF THE ILLUSTRATED EMBODIMENTS

Referring to the figures, FIG. 1 identifies a sprinkler reducer support assembly which broadly corresponds to the traditional prior art. A mounting bracket 1, having first and second flanges 2, 3 spaced apart by a bridging portion 4, is located on a latitudinal supporting member 5. The latitudinal supporting member 5 has two opposing ends and is of square or rectangular cross section.

A longitudinal supporting bracket 6 is located at each opposing end of the latitudinal supporting member 5. Said longitudinal supporting brackets 6 are adapted to receive the upper edge of a ceiling support member 7 and one end of the latitudinal supporting member 5. The latitudinal supporting member 5 is thus supported above the ceiling support members 7.

The mounting bracket 1 has a mounting channel defined by the spacing between said first 2 and second 3 flanges, closely corresponding to the height of the latitudinal supporting member 5. The mounting bracket 1 is located on to the latitudinal support member 5 via the mounting channel before the sprinkler reducer 8 is located into the mounting bracket 1. The sprinkler head will need to be mounted in the reducer after it has been located in the mounting bracket.

The mounting bracket 1 is secured to the latitudinal support member 5 by way of one or more set screws 9 inserted from the outer face of the bridging portion 4, pushing the latitudinal supporting member 5 into engagement with the sprinkler reducer 8.

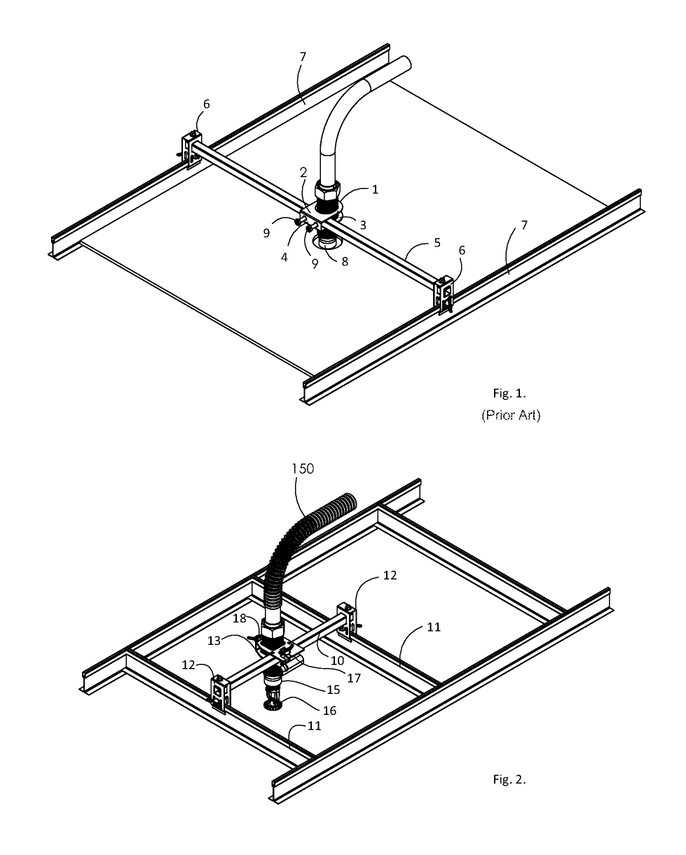

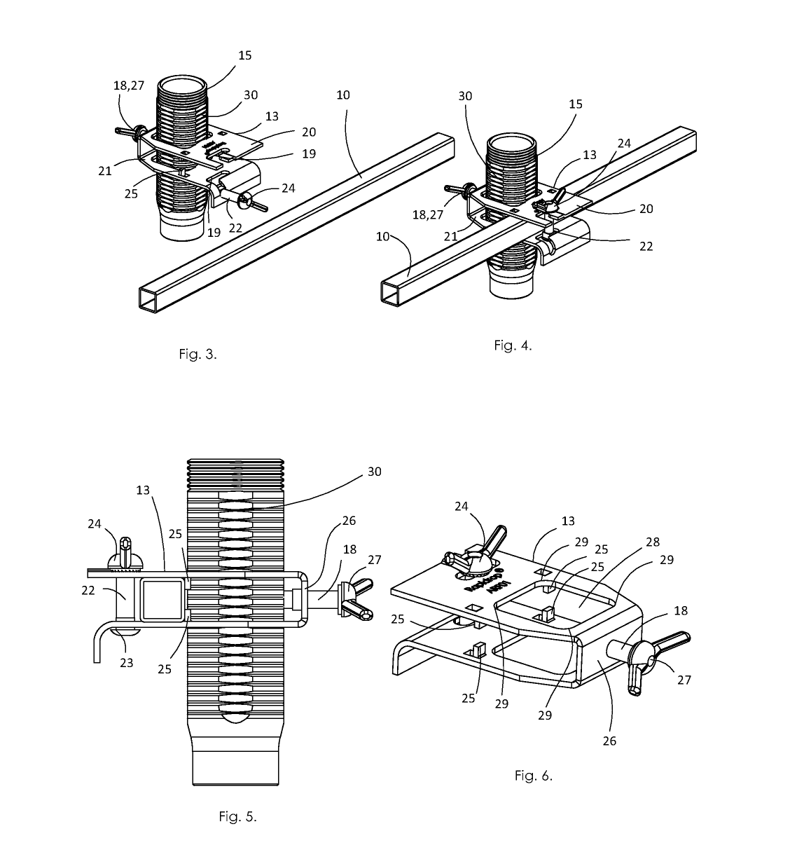

FIGS. 2 to 6 show various views of a first embodiment of the invention. A latitudinal supporting member 10 is supported between two ceiling members 11 by way of a longitudinal supporting bracket 12 located at each end of the latitudinal supporting member 10. The latitudinal supporting member 10 and longitudinal supporting brackets 12 are pre-assembled prior to installing into a ceiling space.

A pre-assembly comprising of a mounting bracket 13, a sprinkler reducer 15, a flexible pipe 150 and a sprinkler head 16 with inner escutcheon ring (not shown) is located on to the latitudinal supporting member 10 and retained by a combination of a locking unit 17 and a mechanical fastener, preferably a set screw 18. The locking unit 17 comprises matching shaped cut-outs 19 in both an upper and lower flange 20, 21, a swivel locking stop bolt 22 with head 23 and a corresponding nut with winged tabs 24. The swivel locking stop bolt 22 and nut 24 are retained by the lower flange 21 and can rotate around a horizontal axis into a cut out slot 19 in the upper flange 20. The nut 24 and swivel locking stop bolt 22 can then be slid sideways before tightening to secure the mounting bracket 13 on to the latitudinal supporting member 10.

The internal faces of the mounting bracket defined by the upper 20 and lower 21 flanges are each provided with two tabs 25 bent at ninety degrees which limit the positioning of the mounting bracket 13 on the latitudinal supporting member 10. The mounting bracket 13, has a square aperture 28, with radiused corners 29, located adjacent to the base wall 26 in both the upper 20 and lower 21 flanges. The sprinkler reducer 15 is inserted through the aperture 28 and the provision of flattened areas 30 on the outer diameter of the sprinkler reducer allows for engagement with the profile edges of the aperture 28. This provides for an effective method of preventing rotation of the sprinkler reducer 15 once it has been pre-installed into the mounting bracket 13.

The set screw 18 is threaded into a threaded hole (not shown), in the base wall 26 joining the upper 20 and lower 21 flanges, tightens against the sprinkler reducer 15 thus pushing it tight against the latitudinal supporting member 10. The set screw 18 will preferably have wing tabs 27 in order to negate the need for use of a tool to turn the set screw 18 in the threaded hole.

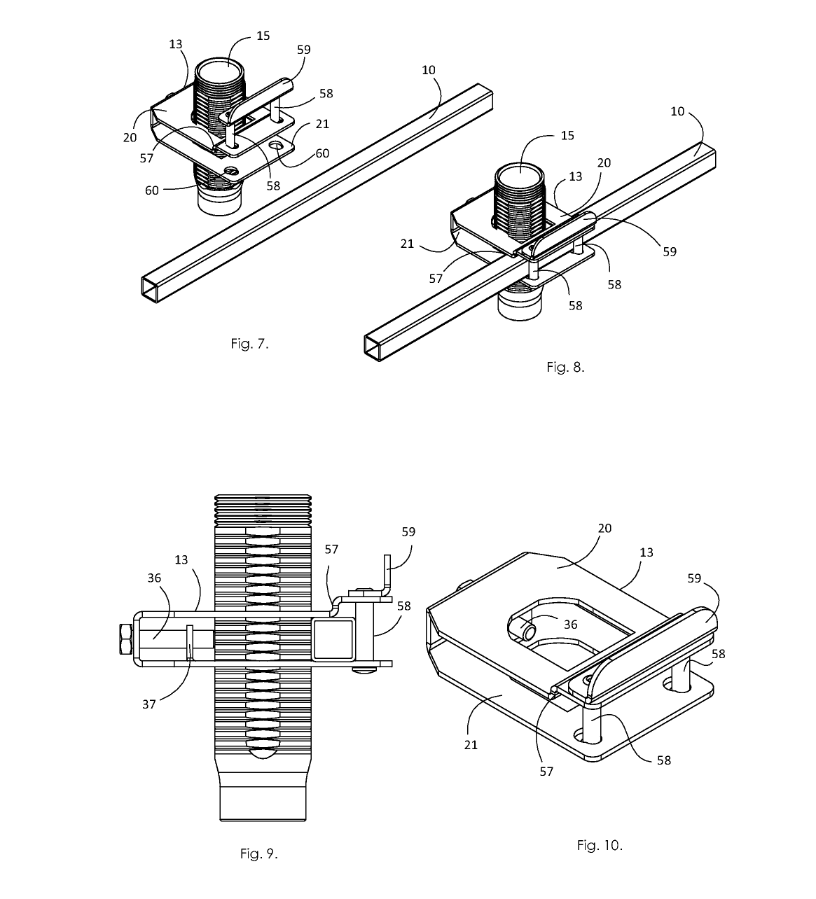

FIGS. 7 to 10 show various views of a second embodiment of the invention. This embodiment differs from the previous embodiments only in the design of the mounting bracket 13. The mounting bracket 13 in this embodiment has a dogleg 57 in the upper horizontal flange 20 to raise the end portion of the upper horizontal flange 20 up a pre-determined distance in order to accommodate the heads of the locking pins 58.

The locking pin assembly comprises of two pins 58 joined together by a locking plate 59. The locking pin assembly is inserted through two elongated holes (not shown) in the horizontal portion of the dogleg 57 and passes through two corresponding holes 60 in the lower horizontal flange 21. A mechanical fastener, preferably a set screw 36, is provided which passes through a threaded hole (not shown) in the base wall 26 from the outside and passes through a clearance hole in the down tab 37. The set screw 36 pushes against the sprinkler reducer 15. The sprinkler reducer 15 is pushed against the latitudinal supporting member 10 which in turn pushes the locking pins 58 into the part of the shaped holes 60 having reduced area. This locks the locking pins 58 in position meaning that the locking pin assembly cannot be raised until the set screw 36 is withdrawn.

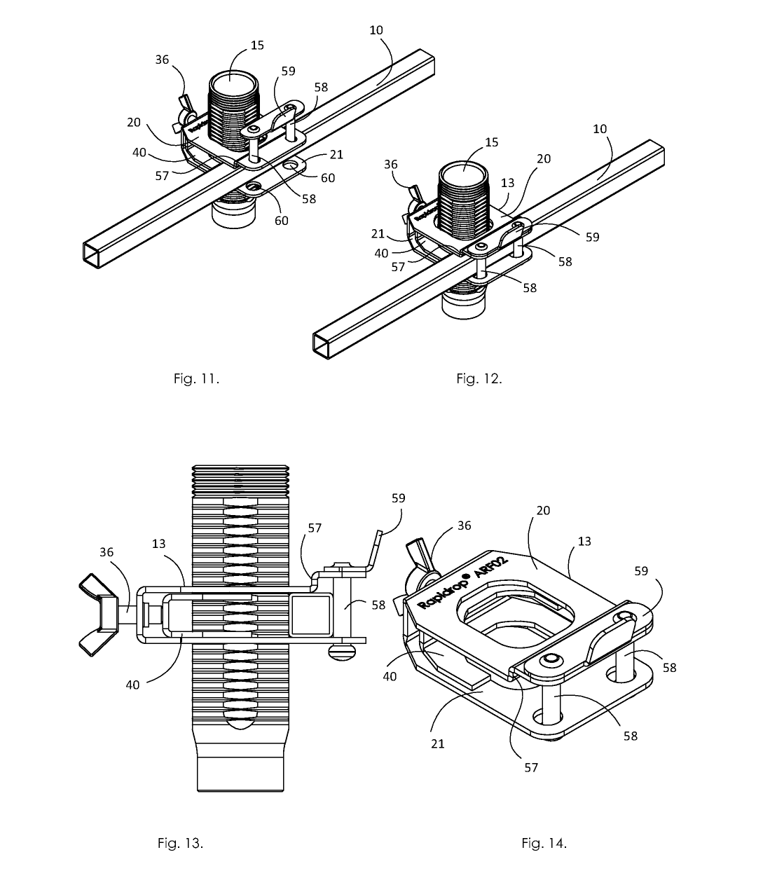

FIGS. 11 to 14 show views corresponding to those of FIGS. 7 to 10 of a third embodiment which is a modification of the second embodiment, in which the set screw 36 is a winged screw which, instead of acting directly on the sprinkler reducer 15, instead acts on an intermediate slidable clamping member 40 which is shaped to engage around one side of the sprinkler reducer 15. As the winged screw 36 is rotated, it bears against the clamping member 40 and urges it into engagement with the sprinkler reducer 15, which is in turn clamped against the latitudinal supporting member 10 when the locking pins 58 are in position, as described with reference to FIGS. 7 to 10, to retain the latitudinal supporting member within the bracket 13.

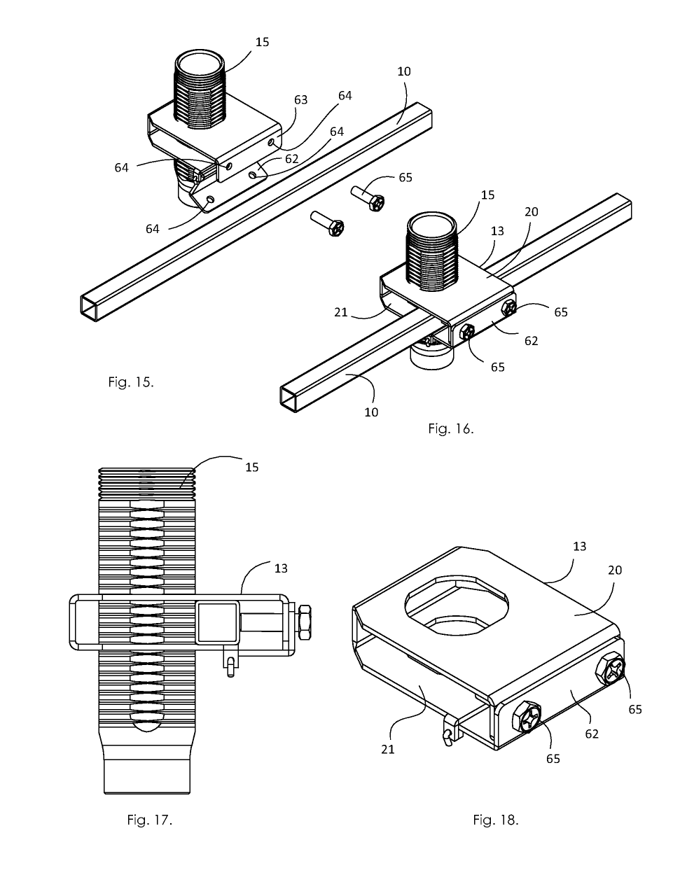

FIGS. 15 to 18 show various views of a fourth embodiment of the invention. This embodiment differs from previous embodiments only in the design of the mounting bracket 13. The mounting bracket in this embodiment has a hinged, L-shaped bracket 62 attached to the lower horizontal flange 21. When closed, the hinged bracket 62 lines up with a vertical flange 63 extending downwards from the upper horizontal flange 20.

Two set screws 65 are threaded through the hinged bracket 62 and vertical flange 63, wherein either of or both of the hinged bracket 62 and vertical flange 63 have threaded holes 64. The set screws 65 extend through the hinged bracket 62 and vertical flange 63 to such a distance that they push against the latitudinal supporting member 10 thus pushing it firmly against the sprinkler reducer 15.

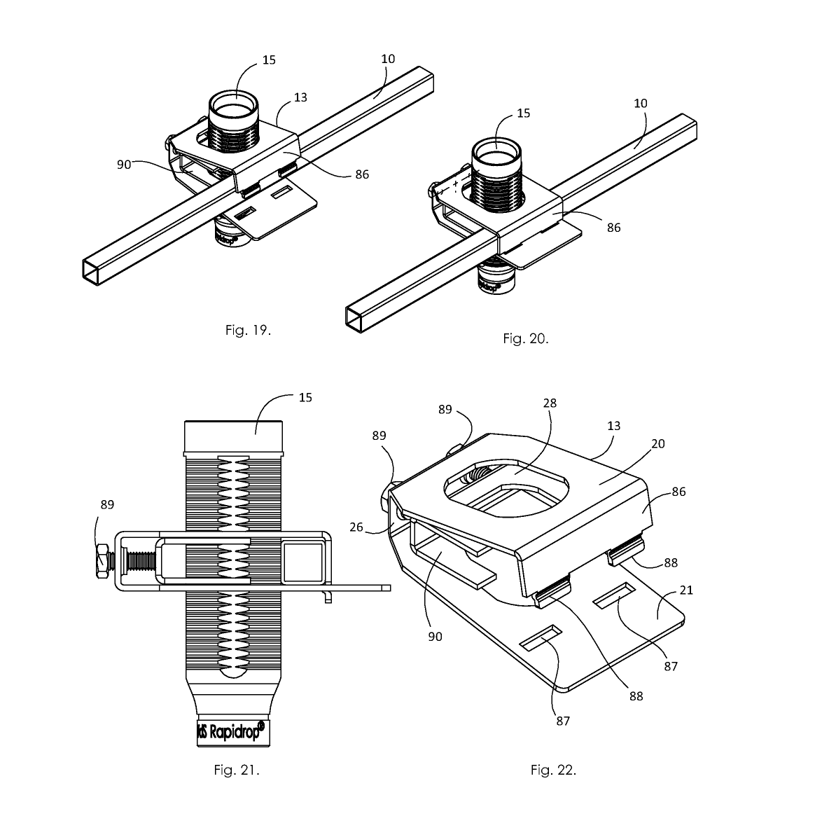

FIGS. 19 to 22 show various views of a fifth embodiment of the invention. This embodiment differs from previous embodiments only in the design of the mounting bracket 13. The mounting bracket 13 in this embodiment is supplied in the open position (the legs not parallel) to allow entry of the latitudinal supporting member 10. Once the latitudinal supporting member 10 is in position, the legs of the mounting bracket 13 are closed together by hand. They may stay naturally in the closed position or be held in by hand until the set screws 89 are tightened to lock them in place.

A front vertical flange 86, extending downwards from the upper horizontal flange 20, is provided with two retaining tabs 88 which locate and engage into corresponding slots 87 in the lower horizontal flange 21 which extends beyond the front vertical flange 86.

The mounting bracket 13 in this embodiment further comprises two set screws 89 inserted through respective threaded holes (Not Shown) in the base wall 26. The set screws 89, once tightened, push against a retaining sleeve 90 which is moved towards and engages with the sprinkler reducer 15.

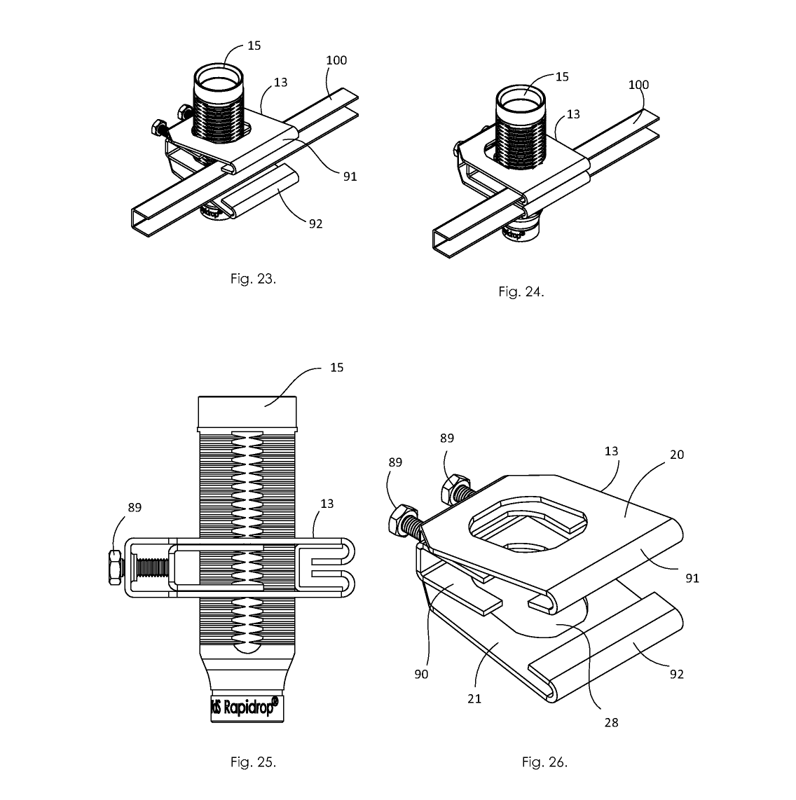

FIGS. 23 to 26 show various views of a sixth embodiment of the invention. This embodiment differs from previous embodiments only in the design of the mounting bracket 13 and the fact that the latitudinal support member 100 is a C section. The mounting bracket 13 in this embodiment is supplied in the open position (the legs not parallel) to allow entry of the latitudinal supporting member 100. Once the latitudinal supporting member 100 is in position, the legs of the mounting bracket 13 are closed together by hand. They may stay naturally in the closed position or be held in by hand until the set screws 89 are tightened to lock them in place. The end of each of both of the upper 20 and lower 21 horizontal flanges, opposite to the base wall 26, are provided with respective one hundred and eighty degree return flanges 91, 92. The latitudinal supporting member 100, which in this embodiment is a channel, locates between the upper 20 and lower 21 horizontal flanges. Once the mounting bracket 13 is closed, the tension applied against the upper and lower flanges of the latitudinal supporting member 100, holds it securely in place.

The set screws 89 inserted through threaded holes (Not Shown) in the base wall 26. The set screws 89 push against a retaining sleeve 90 which in turn pushes against the sprinkler reducer 15 forcing it to move hard against the latitudinal supporting member 100.

It will be appreciated that, while the invention has been described an illustrated with respect to straight reducers, it is equally applicable to the mounting of angled reducers.

1. A fire sprinkler head mounting assembly for mounting a sprinkler head in a suspended ceiling, the suspended ceiling comprising a grid of suspended rails supporting ceiling panel members between them, the assembly comprising:
a tubular sprinkler reducer having an upper open end provided with a connector for a flexible sprinkler supply pipe and a lower open end adapted to receive a sprinkler head;
a latitudinal supporting member having fixed adjacent to each opposed end thereof a respective supporting bracket which is in turn carried by and attached to a respective one of the suspended rails; and
a mounting bracket located around the sprinkler reducer at a position intermediate said upper and lower open ends, the bracket having first and second spaced-apart flanges extending to one side of the sprinkler reducer to define between them a horizontally-extending mounting channel into which the latitudinal supporting member can pass when the mounting bracket carrying the sprinkler reducer is located on to the latitudinal supporting member, the mounting bracket comprising at least one closure member for closing the mounting channel after the latitudinal supporting member is located therein.

2. An assembly according to claim 1, wherein said at least one closure member is configured to clamp the bracket on to the latitudinal supporting member when the mounting channel is closed.

3. An assembly according to claim 1, further comprising clamping means for clamping the sprinkler reducer in the mounting bracket.

4. An assembly according to claim 3, further comprising securing means for securing the mounting bracket to the latitudinal supporting member.

5. An assembly according to claim 1, wherein the sprinkler reducer has an external cross section having diametrically opposed flat portions and the first and second flanges of the mounting bracket each include an aperture for receiving the reducer therein, the apertures being provided with diametrically-opposed straight side portions corresponding to and co-operable with the said flat portions in the cross-section of the sprinkler reducer, whereby to prevent rotation of the sprinkler reducer relative to the bracket.

6. An assembly according to claim 3, wherein the clamping means comprise a screw passing through a threaded hole in the mounting bracket, the screw engaging the sprinkler reducer.

7. An assembly according to claim 3, wherein the clamping means comprise a screw passing through a threaded hole in the mounting bracket, the screw engaging a slidable member carried within the mounting bracket, the slidable member being urged by the screw into engagement with the sprinkler reducer.

8. An assembly according to claim 2, wherein said at least one closure member comprises a screw mounted on said first flange and engageable with said second flange, whereby rotation of the screw applies a clamping force to the latitudinal supporting member between said flanges.

9. An assembly according to claim 3, wherein the clamping means comprises a screw passing through a threaded hole in said at least one closure member to engage the latitudinal supporting member and to urge it into clamping engagement with the sprinkler reducer, thereby to clamp the latitudinal supporting member and the sprinkler reducer in the mounting bracket.

10. An assembly according to claim 1, wherein the mounting bracket further comprises a vertical flange extending vertically from said first flange and having a cut-out accommodating at least one fastener which pivots into a corresponding cut-out in a flange extending vertically from said second flange, and one or more holes through accommodating at least one corresponding fastener which acts against the latitudinal supporting member.

11. An assembly according to claim 1, wherein the mounting bracket further comprises a vertical flange extending vertically from said first flange and having a cut-out accommodating at least one fastener which pivots into a corresponding cut-out in a flange extending vertically from said second flange.

12. An assembly according to claim 1, wherein the mounting bracket further comprises a hinged portion provided as part of the first flange and containing at least one hole through and said second flange has a vertical flange extending downwardly with corresponding holes, said holes lining up with the holes on the hinged portion when the locking unit is in a closed position and engaged by one or more fasteners.

13. An assembly according to claim 1, wherein the mounting bracket further comprises a vertical flange extending vertically downwards from said first flange and provided with at least one tab at the end thereof engageable with a corresponding cut-out in said second flange, whereby when the clamping means is operated to clamp the reducer and the latitudinal supporting member into engagement with each other, said at least one tab is caused to press against a side of the cut-out to hold the vertical flange firmly in position.

14. An assembly according to claim 1, wherein each of said first and second flanges is provided with a return flange engaging on said latitudinal supporting member, whereby to transmit clamping force to said latitudinal supporting member when the clamping means is operated.

15. A fire sprinkler system in a building having a suspended ceiling, the suspended ceiling comprising a grid of suspended rails supporting ceiling panel members between them, the system comprising a plurality of sprinkler heads, each carried by a head mounting assembly comprising:
a tubular sprinkler reducer having an upper open end provided with a connector for a flexible sprinkler supply pipe and a lower open end adapted to receive a sprinkler head;
a latitudinal supporting member having fixed adjacent to each opposed end thereof a respective supporting bracket which is in turn carried by and attached to a respective one of the suspended rails; and
a mounting bracket located around the sprinkler reducer at a position intermediate said upper and lower open ends, the bracket having first and second spaced-apart flanges extending to one side of the sprinkler reducer to define between them a horizontally-extending mounting channel into which the latitudinal supporting member can pass when the mounting bracket carrying the sprinkler reducer is located on to the latitudinal supporting member, the mounting bracket comprising at least one closure member for closing the mounting channel after the latitudinal supporting member is located therein.
